(19) United States
(12) Patent Application Publication
(10) Pub. No.: US 2022/0019748 A1
(43) Pub. Date: Jan. 20, 2022

(54) SYSTEMS AND METHODS FOR PREDICTING VEHICLE REPAIRS USING NATURAL LANGUAGE PROCESSING

(71) Applicant: Honeywell International Inc., Morris Plains, NJ (US)

(72) Inventor: Ryan M. KRENZ, Phoenix, AZ (US)

(21) Appl. No.: 16/928,349

(22) Filed: Jul. 14, 2020

(51) Int. Cl. G06F 40/40; G06F 40/10; G10L 15/26; G06Q 10/00; G06F 16/242

(52) U.S. Cl. CPC G06F 40/40; G06F 40/10; G06F 16/243; G06Q 10/20; G10L 15/26

(57) ABSTRACT

A computer-implemented method for predicting vehicle repairs based on a natural language processing (NLP). The method may include: receiving, by one or more processors, natural language data from a user interface; converting, by the one or more processors, the natural language data into text data; generating, by the one or more processors, natural language processed data (NLPD) by performing NLP on the text data and/or the natural language data; comparing, by the one or more processors, the NLPD to repair data stored in a repair database; determining, by the one or more processors, predicted repair data based on the comparing of the NLPD and the repair data; and transmitting, by the one or more processors, the predicted repair data to the user interface.

### TECHNICAL FIELD

Various embodiments of the present disclosure generally relate to vehicle maintenance and, more particularly, to processing natural language to predict vehicle repairs.

### BACKGROUND

Generally, a defect report log for a vehicle, such as an aircraft, is generated during vehicle maintenance. When a vehicle analyst receives the defect report log, the vehicle analyst reviews the defect report and manually types the information on the defect report into a repair data system. Similarly, clients and mechanics who are interested obtaining repair data must manually type in the required vehicle defect information into the repair data system. Then, the repair data system determines what repairs may be necessary and/or what parts may need to be replaced in order to resolve the defective issues described in the vehicle defect information. However, manually inputting a potentially lengthy defect report log or the required information to determine potentially necessary repairs or parts for the vehicles can be cumbersome and time consuming.

Therefore, there is a need for systems and methods for determining necessary vehicle repairs or parts without having to manually input defect reports or required information by the user.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF DISCLOSURE

According to certain aspects of the disclosure, systems and methods are disclosed to provide translation of natural language queries into database query expressions. Each of the examples disclosed herein may include one or more of the features described in connection with any of the other disclosed examples.

In one embodiment, a computer-implemented method is disclosed for predicting vehicle repairs based on a natural language processing (NLP). The method comprises: receiving, by one or more processors, natural language data from a user interface; converting, by the one or more processors, the data; generating, by the one or more processors, natural language processed data NLPD by performing NLP on the text data and/or the natural language data; comparing, by the one or more processors, the NLPD to repair data stored in a repair database; determining, by the one or more processors, predicted repair data based on the comparing of the NLPD to the repair data; and transmitting, by the one or more processors, the predicted repair data to the user interface.

In accordance with another embodiment, a computer-implemented system is disclosed for predicting vehicle repairs based on a natural language processing (NLP). The computer-implemented system comprises: a memory storing instructions, and one or more processors configured to execute the instructions to perform operations including: receiving, by the one or more processors, natural language data from a user interface; converting, by the one or more processors, the natural language data into text data; generating, by the one or more processors, NLPD by performing NLP on the text data and/or the natural language data; comparing, by the one or more processors, the NLPD to repair data stored in a repair database; determining, by the one or more processors, predicted repair data based on the comparing of the NLPD to the repair data; and transmitting, by the one or more processors, the predicted repair data to the user interface.

In accordance with another embodiment, a non-transitory computer-readable medium is disclosed storing instructions that, when executed by one or more processors of a computer system, cause the computer system to perform a method of predicting vehicle repairs based on a natural language processing (NLP). The method comprising: receiving, by one or more processors, natural language data from a user interface; converting, by the one or more processors, the natural language data into text data; generating, by the one or more processors, NLPD by performing NLP on the text data and/or the natural language data; comparing, by the one or more processors, the NLPD to repair data stored in a repair database; determining, by the one or more processors, predicted repair data based on the comparing of the NLPD to the repair data; and transmitting, by the one or more processors, the predicted repair data to the user interface.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which systems, methods, and other aspects of the present disclosure may be implemented.

FIG. 2 depicts an exemplary flow diagram of a repair prediction system, according to one aspect of the present disclosure.

FIG. 3 depicts an exemplary flow diagram of a method for predicting a vehicle repair, according to one aspect of the present disclosure.

FIG. 4 depicts an exemplary computer device or system, in which embodiments of the present disclosure, or portions thereof, may be implemented.

### DETAILED DESCRIPTION OF EMBODIMENTS

As described above, current systems involve users to manually input information into a vehicle repair data system for determining a potential vehicle repair. Therefore, a need exists for systems and methods that may predict a vehicle repair without having to manually input information (e.g., by typing) into the vehicle repair data system.

Accordingly, the following embodiments describe systems and methods for predicting vehicle repairs based on natural language processing (NLP). According to aspects of the present disclosure, a vehicle repair prediction system may be provided to perform NLP on natural language data by provided by a user. For example, a vehicle analyst for reporting vehicle defects or conditions may speak into an analyst device in natural language to provide information on vehicle defects or conditions. The analyst device may then transmit the vehicle defect or condition information in natural language to the vehicle repair prediction system. The vehicle repair prediction system may then convert the received natural language data into text data. Once the natural language data is converted into the text data, the vehicle repair prediction system may perform natural language processing on the text data and/or the natural language data. The vehicle repair predication system may then generated predict repair data, based on a look-up table, for resolving any issues corresponding to the vehicle defect or condition information. The predicted repair data may provide information on a list of predicted repairs and availability and locations of necessary parts to perform the predicted repairs. As described in further detail below, providing the repair prediction system in accordance with the present disclosure may result in improvements in vehicle repair data generation and retrieval technology. In accordance with the present disclosure, allowing a user to easily and conveniently provide vehicle report data to a vehicle repair prediction system in natural language may reduce time consumption while increasing overall efficiency in vehicle repair management.

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

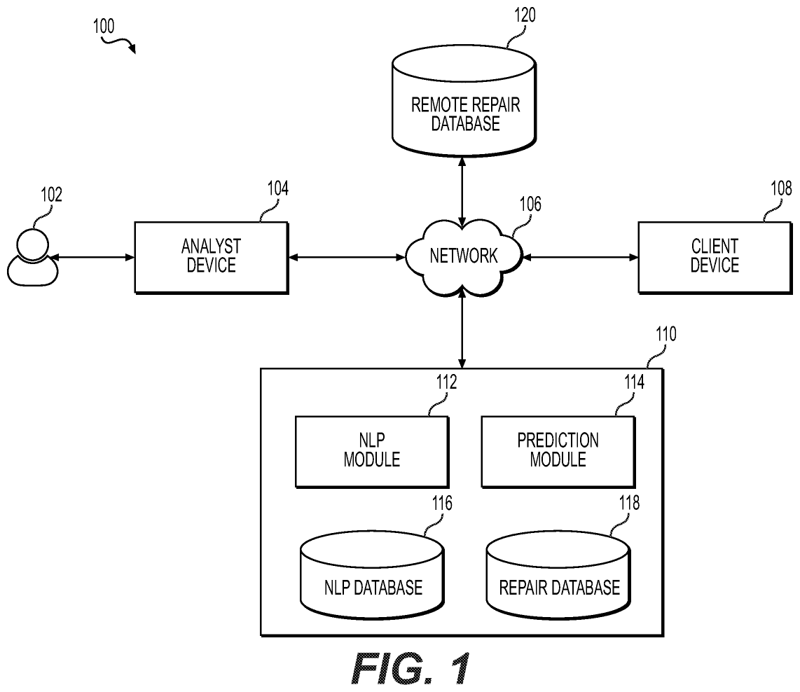

Referring now to the appended drawings, FIG. 1 depicts an exemplary environment 100 in which systems, methods, and other aspects of the present disclosure may be implemented. Environment 100 may include a user 102, an analyst device 104, a repair prediction system 110, and, a client device 108. The analyst device 104, repair prediction system 110, and client device 108 may be connected via a network 106 or may be connected directly or indirectly via one or more buses. The network 106 may include, for example, satellite communication, WiFi, long term evolution (LTE), Bluetooth, a cloud, or any other communications network. The user 102 may be an analyst, a client, a technician, and/or any other entity communicating with the repair prediction system 110 for one or more vehicles. The one or more vehicles, for example, may include an aircraft (e.g., airplanes, helicopters, etc.). However, it is understood that the one or more vehicles may include spacecraft, motor vehicles (e.g., motorcycles, cars, trucks, buses, etc.), railed vehicles (e.g., trains, trams, etc.), watercraft (e.g., ships, boats, submarines, etc.), and/or amphibious vehicles (e.g., hovercraft, screw-propelled vehicles, etc.). The analyst device 104 and the client device 108 may be stationary computers, mobile computers and/or handheld computing devices (e.g., smartphone, tablet, etc.) configured to communicate data or information with the repair prediction system 110. The analyst device 104 and the client device 108 may include one or more input receivers configured to receive input via text, gesture, voice, and/or any other type of input for transmitting input data to the repair prediction system 110. The input receiver may be, for example, a microphone, a keyboard, a capacitive touch screen, an optical detector, or any other input receiver configured to receive input from the user 102. For example, the user 102 or a client may speak into the analyst device 104 or the client device 108, in natural language, to provide information regarding vehicle maintenance including, for example, defects, parts, condition, and/or functionality of the one or more vehicles.

The repair prediction system 110 may comprise an NLP module 112, a prediction module 114, an NLP database 116, and a repair database 118. The repair prediction system may also be connected to a remote repair database 120 storing vehicle repair information. The repair prediction system 110 may be located in an inventory warehouse or a store for vehicles, a data server managing vehicle maintenance, or on a cloud network. The NLP module 112 may receive natural language data from the analyst device 104 or the client device 108 when the user 102 provides information relating to one or more vehicles in natural language. The NLP module 112 may then store the natural language data in the NLP database 110. The NLP module 112 may also perform NLP on the natural language data and transmit the processed natural language data to the prediction module 114. The prediction module 114 may then provide predicted repair data including a list of potential repairs for the one or more vehicles based on the vehicle repair data stored in the repair database 118.

As indicated above, FIG. 1 is provided merely as an example. Other examples are possible and may differ from what was described with regard to FIG. 1. The number and arrangement of devices and networks shown in FIG. 1 are provided as an example. In practice, there may be additional devices, fewer devices and/or networks, different devices and/or networks, or differently arranged devices and/or networks than those shown in FIG. 1. Additionally, or alternatively, a set of devices (e.g., one or more devices) of environment 100 may perform one or more functions described as being performed by another set of devices of environment 100.

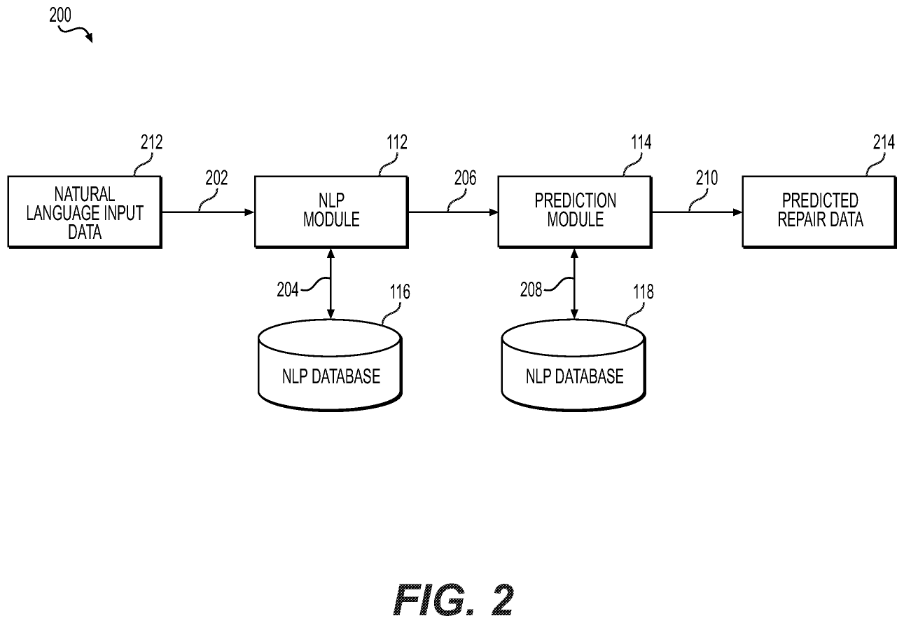

FIG. 2 depicts an exemplary flow diagram 200 of the repair prediction system 110. Flow diagram 200 may begin when the user 102 (e.g., vehicle analyst) provides, for example, a voice generated natural language input data 212 (NLID) by speaking into the analyst device 104 illustrated in FIG. 1. The NLID may include conditions or defects relating to the one or more vehicles. For example, defective functionality, defective parts, insufficient performance, and or any other maintenance conditions relating to the one or more vehicles. At step 202, the analyst device 104 may transmit the NLID 212 to the NLP module 112 illustrated in FIG. 1. At step 204, the NLP module 112 may translate or convert the NLID 212 into text data and store the text data into the NLP database 116 for further processing. For example, the NLP module 112 may perform speech-to-text conversion on the NLID to generate the text data of the NLID 212. Further, the NLP module 112 may perform natural language processing on the converted text data and/or the NLID 212 to generate natural language processed data (NLPD). The NLP module 112 may categorize the NLPD into corresponding vehicle defects or conditions. The NLP, in accordance with the present disclosure, may be performed by, for example, parsing the sentence structure of the text data and determining the meaning of the text data. In some examples, the NLP may be based on keyword matching or phrase matching. In some examples, the speech-to-text conversion and/or natural language processing may be performed by a machine learning model (e.g., an artificial neural network) trained to interpret the voice communication and/or the text transcript. The NLP module 112 may include one or more of a natural language understanding processor, artificial intelligence, and/or cognitive bot service for performing NLP.

At step 206, the NLP module 112 may transmit the NLPD to the prediction module 114. At step 208, the prediction module 114 may communicate with the repair database 118 to compare the NLPD with the vehicle repair data in a look-up table of the repair database 118. The repair data in the look-up table may include information regarding the vehicle repairs corresponding to the defects and/or conditions described in the NLPD. In another embodiment, the look-up table may be located in the remote repair database 120 illustrated in FIG. 1. At step 210, the prediction module 114 may provide, based on the look-up table entries, predicted repair data 214 to the user 102 via the analyst device 104 or the client device 108. The predicted repair data 214 may include a list of potential repairs that may resolve the issues in the one or more vehicles identified by the NLPD. The predicted repair data 214 may also include the parts necessary to perform the potential repairs, availability (e.g., inventory status) of the parts, and/or the locations (e.g., aisle or shelf location in a store or a warehouse of the carrier of the parts) of the parts for the potential repairs.

In an exemplary embodiment, the user 102 may provide information regarding a result of performing at least one of the repairs listed in the predicted repair data 214 to the repair prediction system 110. The repair prediction system 110 may then update the look-up table in the repair database 118 and/or the remote repair database 120 to improve the statistical likelihood of the predicted repair data 214. The repair prediction system may update the look-up table by categorizing the repair data in the repair database 118 and/or the remote repair database 120 by correlating the predicted repair data 214 to the NLPD. Further, the user 102 (e.g., analyst, client, technician, or a vendor) may use the client device 108 to perform a search in the repair database 118 or the remote repair database 120 by using voice, natural language and/or the NLP in accordance with the present disclosure. The search may include, for example, a search for parts necessary to perform potential repairs for one or more vehicles, availability (e.g., inventory status) of the parts, and/or the locations (e.g., aisle or shelf location in a store or a warehouse of the carrier of the parts) of the parts for the potential repairs.

Although FIG. 2 shows example blocks, in some implementations, flow diagram 200 may include additional blocks, fewer blocks, different blocks, or differently arranged blocks than those depicted in FIG. 2. Additionally, or alternatively, two or more of the blocks of flow diagram 200 may be performed in parallel.

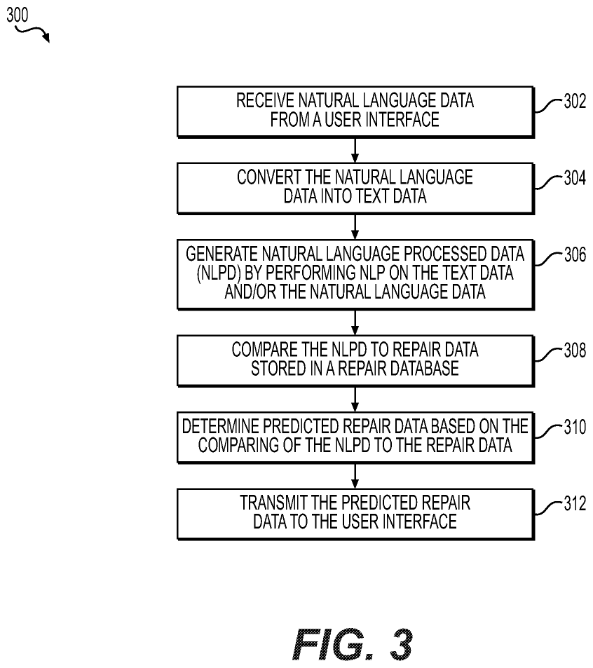

FIG. 3 depicts an exemplary flow diagram 300 of a method for predicting vehicle repairs based on a natural processing (NLP) by the repair prediction system 110. At step 302, the repair prediction system 110 may receive natural language data from a user interface. The analyst device 104 or the client device 108 may generate the natural language data, for example, when the user 102 speaks into the analyst device 104 or the client device 108 in natural language. The user 102 may provide information regarding, for example, defective functionality, defective parts, insufficient performance, and or any other maintenance conditions relating to one or more vehicles. At step 304, the repair prediction system 110 may convert the natural language data into text data. The repair prediction system 110 may convert the text data by performing speech-to-text processing on the natural language data. The converted text data may be stored in the NLP database 116 for further processing.

At step 306, the repair prediction system 110 may generate natural language processed data (NLPD) by performing NLP on the text data and/or the natural language data. The repair prediction system 110 may perform the NLP by, for example, parsing the sentence structure of the text and determining the meaning of the text transcript or may be based on keyword matching or phrase matching. In an exemplary embodiment, the repair prediction system 110 may perform the NLP with one or more of a natural language understanding processor, artificial intelligence, and/or cognitive bot service. At step 308, the repair prediction system 110 may compare the NLPD to repair data stored in a repair database. The repair database may be located in inventory warehouse or a store for vehicles, a data server managing vehicle maintenance, or on a cloud network. At step 310, the repair prediction system 110 may determine predicted repair data based on the comparing of the NLPD to the repair data. The predicted repair data may include a list of potential repairs that may resolve the issues in the one or more vehicles identified in the NLPD. The predicted repair data may also include the parts necessary to perform the potential repairs, availability of the parts, and/or the location of the parts for the potential repairs.

At step 312, the repair prediction system 110 may transmit the predicted repair data to the user interface. In an exemplary embodiment, the repair prediction system 110 may receive a result of a repair performed based on the predicted repair data. The repair prediction system 110 may then update the look-up table in the repair database 118 and/or the remote repair database 120 based on the result of the repair. The repair prediction system 110 may then update the look-up table by categorizing the repair data in the repair database 118 and/or the remote repair database 120 by correlating the predicted repair data to the NLPD.

Although FIG. 3 shows example blocks, in some implementations, flow diagram 300 may include additional blocks, fewer blocks, different blocks, or differently arranged blocks than those depicted in FIG. 3. Additionally, or alternatively, two or more of the blocks of flow diagram 300 may be performed in parallel.

In general, any process discussed in this disclosure that is understood to be computer-implementable, such as the process shown in FIGS. 2 and 3 and the processes described in connection with FIGS. 1-3, may be performed by one or more processors of a computer system, such as the repair prediction system 112, the analyst device 104, and the client device 108, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or another type of processing unit.

A computer system, such as the repair prediction system 112, the analyst device 104, and the client device 108, may include one or more computing devices. If the one or more processors of the computer system are implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

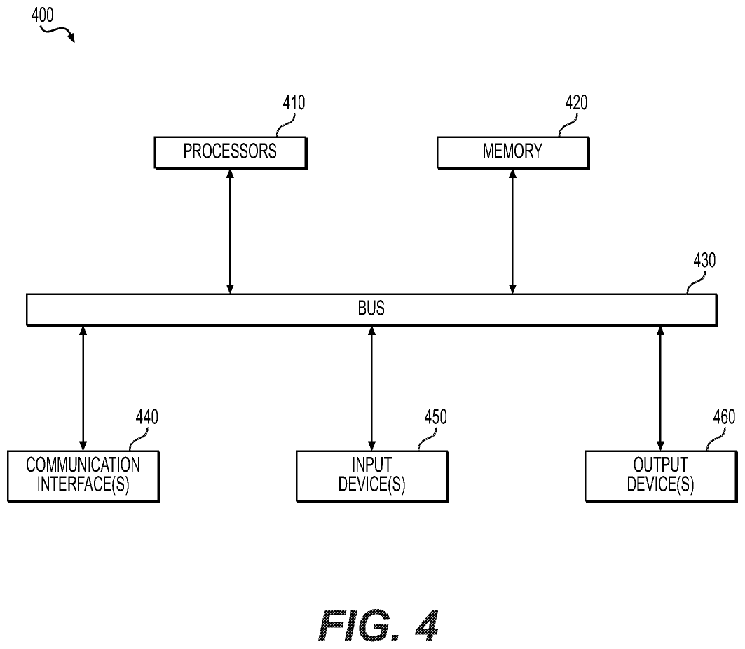

FIG. 4 illustrates an example of a computing device 400 of a computer system. The computing device 400 may include processor(s) 410 (e.g., CPU, GPU, or other processing unit), a memory 420, and communication interface(s) 440 (e.g., a network interface) to communicate with other devices. Memory 420 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 420. The computing device 400 may, in some embodiments, further include input device(s) 450 (e.g., a keyboard, mouse, or touchscreen) and output device(s) 460 (e.g., a display, printer). For example, if the EFB 110 is embodied as a tablet computer, as shown in FIG. 1, the EFB may have a touchscreen and a display. The aforementioned elements of the computing device 400 may be connected to one another through a bus 430, which represents one or more busses. In some embodiments, the processor(s) 410 of the computing device 400 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, configure and/or cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

What is claimed is:

1. A computer-implemented method for predicting vehicle repairs based on a natural language processing (NLP), the method comprising:
receiving, by one or more processors, natural language data from a user interface;
converting, by the one or more processors, the natural language data into text data;
generating, by the one or more processors, natural language processed data (NLPD) by performing NLP on the text data and/or the natural language data;
comparing, by the one or more processors, the NLPD to repair data stored in a repair database;
determining, by the one or more processors, predicted repair data based on the comparing of the NLPD and the repair data; and
transmitting, by the one or more processors, the predicted repair data to the user interface.

2. The method of claim 1, wherein the step of converting the natural language data into the text data comprises:
performing, by the one or more processors, a speech-to-text processing on the natural language data.

3. The method of claim 1, wherein the step of generating the NLPD comprises using one or more of a natural language understanding processor, artificial intelligence, and/or cognitive bot service.

4. The method of claim 1, further comprising:
storing, by the one or more processors, the text data into a natural language database.

5. The method of claim 1, further comprising:
receiving, by the one or more processors, repair confirmation data from the user; and
categorizing, by the one or more processors, the repair data in the repair database by correlating the predicted repair data to the NLPD.

6. The method of claim 1, wherein the predicted repair data comprises at least one of a list of repair items and a list of locations of the repair items.

7. The method of claim 1, wherein the repair database is located remotely in a cloud network.

8. A computer-implemented system for predicting vehicle repairs based on a natural language processing (NLP), the computer-implemented system comprising:
a memory storing instructions, and
one or more processors configured to execute the instructions to perform operations including:
receiving, by one or more processors, natural language data from a user interface;
converting, by the one or more processors, the natural language data into text data;
generating, by the one or more processors, natural language processed data (NLPD) by performing NLP on the text data and/or the natural language data;
comparing, by the one or more processors, the NLPD to repair data stored in a repair database;
determining, by the one or more processors, predicted repair data based on the comparing of the NLPD and the repair data; and
transmitting, by the one or more processors, the predicted repair data to the user interface.

9. The method of claim 8, wherein the step of converting the natural language data into the text data comprises:
performing, by the one or more processors, a speech-to-text processing on the natural language data.

10. The method of claim 8, wherein the step of generating the NLPD comprises using one or more of a natural language understanding processor, artificial intelligence, and/or cognitive bot service.

11. The method of claim 8, further comprising:
storing, by the one or more processors, the text data into a natural language database; and
categorizing the text data by correlating with the natural language data.

12. The method of claim 8, further comprising:
receiving, by the one or more processors, repair confirmation data from the user; and
categorizing, by the one or more processors, the repair data in the repair database by correlating the predicted repair data to the NLPD.

13. The method of claim 8, wherein the predicted repair data comprises at least one of a list of repair items and a list of locations of the repair items.

14. The method of claim 1, wherein the repair database is located remotely in a cloud network.

15. A non-transitory computer-readable medium storing instructions that, when executed by one or more processors of a computer system, cause the computer system to perform a method of predicting vehicle repairs based on a natural language processing (NLP), the method comprising:
receiving, by one or more processors, natural language data from a user interface;
converting, by the one or more processors, the natural language data into text data;
generating, by the one or more processors, natural language processed data (NLPD) by performing NLP on the text data and/or the natural language data;
comparing, by the one or more processors, the NLPD to repair data stored in a repair database;
determining, by the one or more processors, predicted repair data based on the comparing of the NLPD and the repair data; and
transmitting, by the one or more processors, the predicted repair data to the user interface.

16. The method of claim 14, wherein the step of converting the natural language data into the text data comprises:
performing, by the one or more processors, a speech-to-text processing on the natural language data.

17. The method of claim 14, wherein the step of generating the NLPD comprises using one or more of a natural language understanding processor, artificial intelligence, and/or cognitive bot service.

18. The method of claim 14, further comprising:
storing, by the one or more processors, the text data into a natural language database.

19. The method of claim 14, further comprising:
receiving, by the one or more processors, repair confirmation data from the user; and
categorizing, by the one or more processors, the repair data in the repair database by correlating the predicted repair data to the NLPD.

20. The method of claim 14, wherein the predicted repair data comprises at least one of a list of repair items and a list of locations of the repair items.
